(19) United States
(12) Patent Application Publication
(10) Pub. No.: US 2016/0106142 A1
(43) Pub. Date: Apr. 21, 2016

(54) Additive Manufacturing for Producing Edible Compositions

(71) Applicant: Systems and Materials Research Corporation, Austin, TX (US)

(72) Inventors: Anjan CONTRACTOR, Austin, TX (US); David James IRVIN, Austin, TX (US); Malcolm David PROUTY, Austin, TX (US); Keris Allrich WARD, Austin, TX (US); Jesse Baskin MCDANIEL, Austin, TX (US)

(73) Assignee: Systems and Materials Research Corporation, Austin, TX (US)

(21) Appl. No.: 14/893,520

(22) PCT Filed: May 22, 2014
(86) PCT No.: PCT/US14/39254

§ 371 Date: Nov. 23, 2015

Related U.S. Application Data
(60) Provisional application No. 61/826,480, filed on May 22, 2013.

(51) Int. Cl. A23P 1/08

(52) U.S. Cl. CPC A23P 1/085; A23L 1/0073; A23P 2001/089; A23V 2002/00; B33Y 10/00

(57) ABSTRACT

A 3D food printing system, which can deposit macro- and micro-nutrients in an additive process to prepare a wide variety of different types of food. According to embodiments described herein, a 3D printed food system can be used to rapidly and efficiently prepare meals on demand, rather than in advance, while also allowing nutritional content, flavor, and taste to be customized for individual crew members. In some embodiments, the food can also be prepared in a largely or even completely automated fashion.

### CROSS-REFERENCE TO RELATED APPLICATION

The present application claims priority from PCT Application No. PCT/US2014/39254, filed May 22, 2014, entitled “ADDITIVE MANUFACTURING FOR PRODUCING EDIBLE COMPOSITIONS” by Anjan Contractor et al., which in turn claims priority to U.S. Provisional Patent Application Ser. No. 61/826,480 filed May 22, 2013, entitled “ADDITIVE MANUFACTURING FOR PRODUCING EDIBLE COMPOSITIONS” by Anjan Contractor et al., all of which are all incorporated by reference herein in their entirety.

### FIELD OF THE DISCLOSURE

The present invention relates in general to additive manufacturing of edible composition.

### BACKGROUND

Manned space mission require that the crew be provided with an acceptable, nutritious, and safe food supply while, at the same time, minimizing food volume and mass, power consumption, and waste. Long duration space missions present unique challenges with respect to the preparation, quality, variety, and stability of the food required by crew members. Previously, crew members on long-term space missions (such as lengthy stays aboard the International Space Station) have been fed using a combination of pre-packaged foods, bulk ingredients, and even crops to provide a well-balanced diet. However, the majority of the food must be pre prepared and packaged since cooking in low gravity is difficult and dangerous.

Currently, astronauts select virtually all of food to accompany them on their missions prior to lift off into space. These food items are packaged into meals ready-to-eat (MRE) pouches to ensure they remain sterile up until consumption, and make access to the food as easy as possible in restricted space environments. Unfortunately, MREs have several drawbacks including a limited shelf life (1-3 years), limited variety, packaging and food waste after consumption, and nutritional decay over time. It has also been reported by astronauts that taste is altered in space environments—for example making traditionally spicy foods seems less flavorful. Because all of the food is prepackaged before launch, it is also difficult to accommodate the individual tastes or nutritional requirements of crew members, especially since those tastes and nutritional requirements may change during a lengthy space mission.

There is a need for an improved system for food preparation using components with a longer shelf life that can be used to rapidly and efficiently prepare meals in a largely or even completely automated fashion, while also allowing nutritional content and taste to be individually customized.

### BRIEF DESCRIPTION OF THE DRAWINGS

The present disclosure may be better understood, and its numerous features and advantages made apparent to those skilled in the art by referencing the accompanying drawings.

FIG. 1 schematically illustrates a 3D printed food system according to an embodiment of the invention.

FIG. 2A schematically illustrates a long-term ingredient storage module for use with the 3D printed food system.

FIG. 2B schematically illustrates another embodiment of a long-term ingredient storage module for use with the 3D printed food system.

FIG. 3 schematically illustrates a master storage module according to an embodiment.

FIG. 4 schematically illustrates an ingredient mixing module according to an embodiment.

FIG. schematically illustrates a 3D dispenser according to an embodiment.

FIG. 6 schematically illustrates a cleaning module according to an embodiment.

FIG. 7 schematically illustrates another embodiment of a 3D printed food system.

### DETAILED DESCRIPTION OF PREFERRED EMBODIMENTS

Embodiments of the present invention are directed to a 3D food printing system, which can deposit macro- and micro-nutrients in an additive process to prepare a wide variety of different types of food. Although not limited to any particular uses, embodiments of the present invention are particularly applicable to providing food for crew members during long-duration space missions. According to embodiments described herein, a 3D printed food system can be used to rapidly and efficiently prepare meals on demand, rather than in advance, while also allowing nutritional content, flavor, and taste to be customized for individual crew members. In some embodiments, the food can also be prepared in a largely or even completely automated fashion.

3D printing, also referred to as additive manufacturing, is a known process used to create physical objects from a digital design. Using 3D printing, virtual designs from a CAD model are transformed into horizontal cross-sections and successive layers of material are compiled to create a solid object. There are three most common manufacturing methods of 3D Printing including Stereolithography (SLA), Selective Laser Sintering (SLS) and Fused Deposition Method (FDM). The process has been used to create edible objects. For example, several candy makers have used 3D printing to shape or decorate chocolate.

According to embodiments of the invention, a 3D printing process is used to combine precisely metered amounts of stored food products and/or food components such as isolated macro- and micronutrients to produce a wide range of foods. Isolated macro- and micronutrients are isolated nutritive substances that have been extracted or purified from natural food sources or, in some case, chemically synthesized. An example of an isolated nutritional component would be unflavored protein powder, which can be extracted from a number of different whole food sources such as milk or eggs. In some embodiments of the invention, the stored food products could comprise isolated protein powder; while in other embodiments whole food sources such as milk or eggs could be stored, either instead of or in addition to the powdered isolated protein powder. The term “synthetic food” is sometimes used to refer to food that is at least partially manufactured by combining isolated nutritive substances such as proteins or their component amino acids, carbohydrates, fats, and/or micronutrients such as vitamins and minerals.

According to embodiments of the invention, once a desired food mixture has been created, the final food mixture can also be heated or cooked using an integral oven or other appropriate heating mechanism. Further, 3D printed food systems as described herein can also substantially reduce or even eliminate food waste, which is highly desirable for long-distance space missions as well as for other terrestrial uses. Also, as described in greater detail below, embodiments of the invention can automatically adjust recipes to compensate for decay in the nutritional values and/or taste of various nutritional components, to produce food with an improved nutritional content, or to provide food having customized nutritional content and taste. Finally, in some embodiments, recipes can also be automatically adjusted based upon feedback from previously prepared meals and/or upon the inventory or age of related or interchangeable nutritional components.

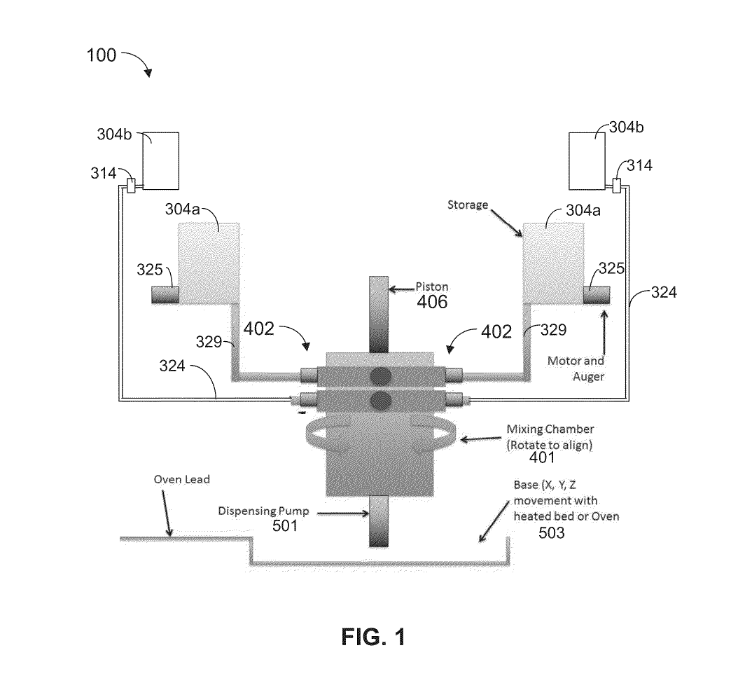

FIG. 1 schematically illustrates a 3D printed food system 100 according to an embodiment of the invention that can be used to practice an additive manufacturing process (such as 3D printing) is used to produce a wide variety of synthetic food, including dishes comprising a number of different food component types (for example, ravioli, which has a pasta shell surrounding a meat or cheese filling) or complete meals including a number of different dishes. The system of FIG. 1 is comprised of a number of individual subsystems, or modules (described in detail below) which combine to complete each step of the food preparation process starting from stored food or nutritional components and finishing with delicious, warm, freshly prepared meals delivered on-demand.

In some embodiments, the 3D printed food system is computer controlled so that food preparation becomes a programmable automated process, with storage, mixing and dispensing systems mechanically integrated with 3D Printer components to formulate a complete assembly. An electronics Master Control System can be used to control all primary functions (Dispensing, Mixing, Printing, and Cooking) at once according to the food recipes. The integrated mechanical system can be controlled by a microcontroller such as the open source microcontroller ARDUINO. All valves, pressure regulators, flow sensors, heaters, flow regulators and power sources will be connected to the microcontroller, which will in turn connect to the software platform of the 3D printer. A master program will conduct a two-way communication from the 3D printer sensors and actuators.

Food preparation using the 3D printed food system 100 can be controlled using individual “recipes,” which consist of computer instructions and operational parameters for preparing a particular food or dish, including dispensing parameters such as the selection and exact quantities of stored food components to be dispensed, mixing instructions controlling how the specified components are combined, 3D printing bed numerical control specifying how the raw food mixture(s) are deposited onto the printing bed, and/or cooking parameters such as heating temperatures and cooking times. In some instances, recipes will be used to mimic the taste and texture of familiar foods while maintaining (or in some cases improving) the nutritional balance and micronutrient effectiveness of the conventional meal or food. A library of recipes can be stored in computer memory and selected by a user. In some embodiments, food preparation will be programmable through a graphical user interface (GUI) running on a single 3D Printed Food system computer. In some embodiments, recipes can also be transmitted over a wireless network connection. For example, in the context of a long-term space flight, additional recipes could be transmitted from mission control to the space craft in transit.

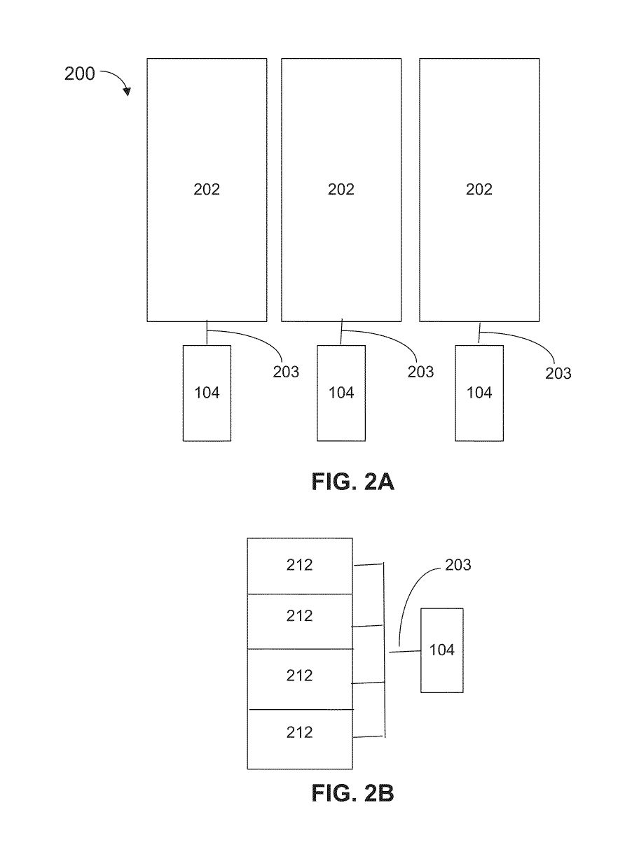

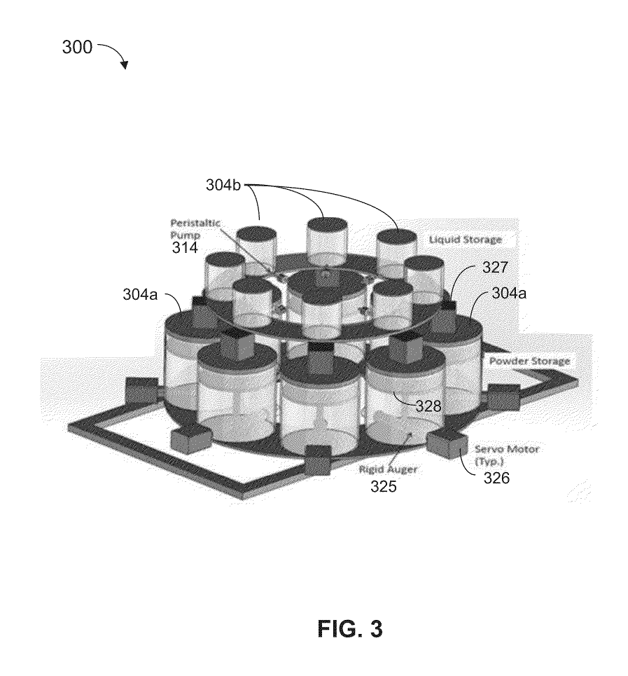

Referring to FIGS. 2A and 2B, long-term ingredient storage module 201 uses prepackaged, hermetically sealed containers 202 for bulk storage of nutritional components before they are transferred to the 3D printed food system 100 of FIG. 1. The stored food products used for meal preparation can comprise bulk storage of common food ingredients such as flour or as nutritional components such as isolated macro- or micronutrients. In general, macronutrients provide the bulk energy required for sustenance, while micronutrients provide the necessary cofactors for metabolism to be carried out. Unflavored macronutrients, such as protein, starch, and fat, can be stored in dried and powdered form. Micronutrients, such as vitamins and minerals, can be isolated and stored as powders, aqueous solutions, or dispersions, depending upon the optimal storage conditions for each micronutrient. It will be understood that the macronutrient components, especially where whole food sources are used, will also provide some of the micronutrients in the final processed food.

Storage containers 202 should be designed for optimal long-term storage and can be formed from thin metal, multilayer plastic film, or metallized Mylar. A suitable storage vessel should have high resistance to permeation of water, oxygen, carbon dioxide, and other gases in order to prevent spoilage or degradation of the contents. The actual storage containers used can vary in size and number based on considerations of available space, logistics, and efficiency. Storing micronutrients in a few large containers 202, as shown in FIG. 2A, can be beneficial in terms of simplicity, lower maintenance requirements, space saving, and a dedicated controlled environment resulting in better efficiency. However, large storage bins can be at a risk of bulk contamination, delay in service due to malfunction, leaks or downtime. A greater number of small containers 212, as shown in FIG. 2B, can provide the benefits of better space management, portability, low probability of large leaks and bulk contamination.

In some embodiments, long-term storage containers 202 can be connected via a leak-proof connection interface 203 to off-line ingredient cartridges 204 suitable for loading into the 3D printer master storage module 110 described below. Ingredient cartridges 204 can be sized to supply ingredients for multiple food preparation runs and to meet multiple crewmembers' nutrition requirements. Crew members will be prompted by the food printer interface (described below) to reload empty or non-present on-line ingredient cartridges. Empty ingredient cartridges can be disconnected (taken off-line) from the 3D printer and connected to appropriate long-term storage containers for refill.

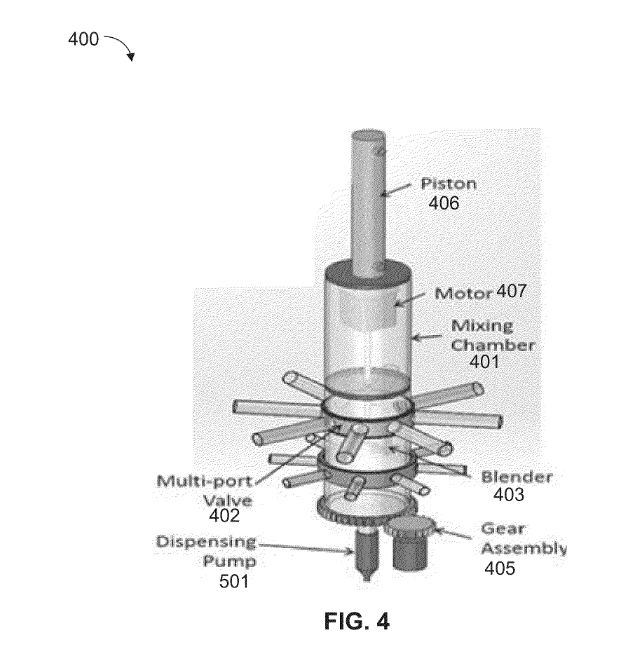

FIG. 3 schematically illustrates a master storage module 300 according to an embodiment of the invention. Filled ingredient cartridges are disconnected from long-term storage containers and moved to the master storage module 300, which comprises on-line ingredient cartridges 304a, 304b. In the embodiment of FIG. 1, the upper row ingredient cartridges 304a are used to hold liquid ingredients including micronutrients, purified flavoring oils, vegetable oils, and water, while the lower row ingredient cartridges 304b contain the dry powder ingredients including common macronutrients and food components. Water or oils (such as olive oil, coconut oil, etc.) used to form a paste with the dried and powdered macronutrient feed stocks are also stored in these upper row ingredient cartridges 304a.

When a recipe is executed by a 3D printed food system such as the embodiment shown in FIG. 1, precise quantities of specified common food ingredients and/or macro- and micro-nutrients stored in ingredient cartridges 304a, 304b are first transferred to an ingredient mixing module 400, which comprises a central mixing chamber 431 where the components are combined and mixed together.

The transfer of liquid from upper row ingredient cartridges 304a can be accomplished, for example, by a positive displacement pump such as a peristaltic pump 314. This type of pump operates in low gravity and will mechanically meter liquids into the mixing chamber if used in conjunction with a stepper or servo motor. When a recipe requiring liquid ingredients is initiated, precise quantities of the specified liquid ingredients can be accurately pumped from the ingredient cartridges to the designated mixing center chamber through flexible hosing 324. In some embodiments, the transfer can be accomplished through the use of pressurized inert gas.

Powder formulations lower row ingredient cartridges 304b can be transferred to the mixing chamber, for example, by an auger system 325 controlled by stepper or servo motors 326. In embodiments intended for low gravity environments, mechanical pressure can be applied by a servo motor 327 and piston 328 that pushes the powder into the auger feeder. This mechanism will allow close contact of ingredients to the auger and dispense precisely metered quantities of powdered components. Rotation of the auger will move the powder through tubing 329 connected directly to the mixing chamber. In some instances, flexible augers can be used to reduce the potential of powder clogging the tubing.

In the embodiment of FIG. 1, the pumps and motors described above interface with a controller and microprocessor for incorporation into the overall 3D printed food system. This allows the precise amounts of macro- and micro-nutrients or other components transferred to the mixing chamber to be controlled by the execution of a particular recipe.

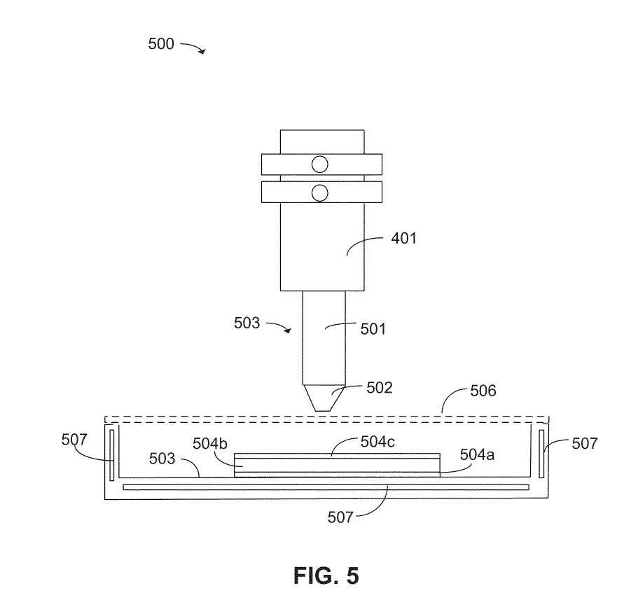

FIG. 4 schematically illustrates an ingredient mixing module 400 according to an embodiment of the invention. Ingredient mixing module 400 comprises mixing chamber 401, a valve system 402 that opens or closes access to the mixing chamber by the hoses or tubing leading from the ingredient cartridges, a mixing mechanism 403 to combine and mix the dry and liquid ingredients and transfer the raw mixture to the 3D dispenser 500. In the embodiment of FIG. 1, mixing chamber 401 comprises a transparent, generally cylindrical body. A cylindrical multi-port valve 402 will allow only one ingredient at a time to be transferred into the mixing chamber to ensure purity and sterility of the stored ingredients.

In some embodiments, multi-port valve 402 comprises multiple tube connections through which ingredients are introduced to the mixing chamber (although any other suitable known valve type or arrangement could also be used). All of the tube connections to multi-port valve 402 are shown cut-away for clarity. Mixing chamber 401 only has one opening through which ingredients can enter. During the transfer of ingredients from the ingredient cartridges to the mixing chamber, the mixing chamber opening can only be aligned with one tube connection (or port) for powder or liquid transfer. In the illustrated embodiment, the mixing chamber can be rotated in either a clockwise or counter-clockwise direction by gear assembly 405 so that the mixing chamber opening can be aligned with each of the ports in turn. This allows for each of the desired ingredients to be added to the mixing chamber, but with a greatly reduced chance of cross-contamination of the various food ingredients.

Once the appropriate amounts of each ingredient or nutritional component for the recipe being prepared have been transferred to the mixing chamber, a mixing mechanism can be used to form a paste from the combination of dry nutrient powder and liquid and to make sure that the different nutritional components are evenly distributed within the raw mixture. In the embodiment of FIG. 1, the mixing mechanism comprises rotating blender blades 403 attached to a reciprocating actuator and motor 407. The desired viscosity for the final mixture will vary from recipe to recipe, but in general the viscosity should be low enough to allow the material to be easily dispersed through the 3D printer nozzle and yet high enough that the deposited food material retains its shape after deposition.

The blades of the mixing chamber can be rotated at controlled speeds, for example in a range from 50-250 RPM, and can change rotational direction. A piston 406 can be used within the mixing chamber to help push the raw mixture out of the mixing chamber and toward the 3D dispenser 500. The slurry/paste formed when the ingredients are mixed is transferred to a positive displacement pump (used for deposition of the raw mixture) via either piston movement or blender rotation. The connection between the mixing chamber and dispensing valve can be a tube with a solenoid valve. The valve will open when the mixing process completes.

Other mixing mechanisms could be employed including, for example, vibration augmentation, auger driven mixing, and piston driven mixing. In some embodiments various mixing parameters can be varied to account for different mixture compositions or viscosities, including, for example, rotation speed, auger blade size, auger size in relation to the volume of the chamber, and applied torque. In particular embodiments, mixing parameters can be controlled via a microprocessor and controller so that the parameters can be adjusted for various recipes.

FIG. 5 illustrates schematically a 3D dispenser 500 according to an embodiment of the invention comprising a positive displacement pump 501, a nozzle 502, and a heated bed 503 on which the food paste is deposited. In some embodiments, dispenser 500 will deposit the raw food paste onto a stage or bed that has been heated to a desired temperature, such as, for example, 130° C. to 220° C. The food paste can be laid down layer by layer 504a, 504b, 504c at precisely controlled locations as specified in the recipe being followed. In the embodiment of FIG. 1, the heated stage or bed 503 is the base of a stand-alone 3D printer that has been integrated with the other subsystems or modules of the 3D printed food system. The printer base is capable of movement in the X, Y, and Z directions under control of an independent microcontroller. The 3D printer can be programmed to position the print platform and control the dispensing mechanisms as required for each individual recipe. The programmed instructions can specify how the deposited food products will be layers and can also include additional programming to automate and synchronize the dispensing, mixing, and printing processes.

In some embodiments, the print heads will have a low waste volume, precise volume control over a wide viscosity range, and be easy to clean. One example of high accuracy dosing technology is the Netzsch NEMO dosing pump, which has dosing accuracies of ±1% volumetric, enabling high-precision nutrient printing for optimized personal nutrition. In some embodiments, a single 3D printer print head and nozzle can be employed to dispense the food mixture, while in other embodiments one or more microjets (similar to an inkjet printer jet) can be employed, either separately or in conjunction with the 3D printer print head and nozzle. In other embodiments, dispenser 500 could also include one or more additional nozzles, either additional nozzle suitable of the 3D deposition process that could be used to speed up the application process or spray nozzles such as inkjet-type nozzles that can be used to apply liquid micronutrients, flavors, or even scents separate from the 3D deposition of the mixed components from the mixing chamber.

In some embodiments, deposited food begins cooking as soon as it is deposited onto the heated bed. In the embodiment of FIG. 1, once all of the food paste has been deposited (and thus all X and Y stage/bed movements have been completed) the Z stage of the 3D printer stage can retract and an automatic cover 506 can slide into place creating an enclosed heated chamber. Kapton heaters 507 embedded within the bed and the enclosure walls can provide a functional oven. In some embodiments, microwave, infrared heating, or an infrared laser could also be used for final cooking.

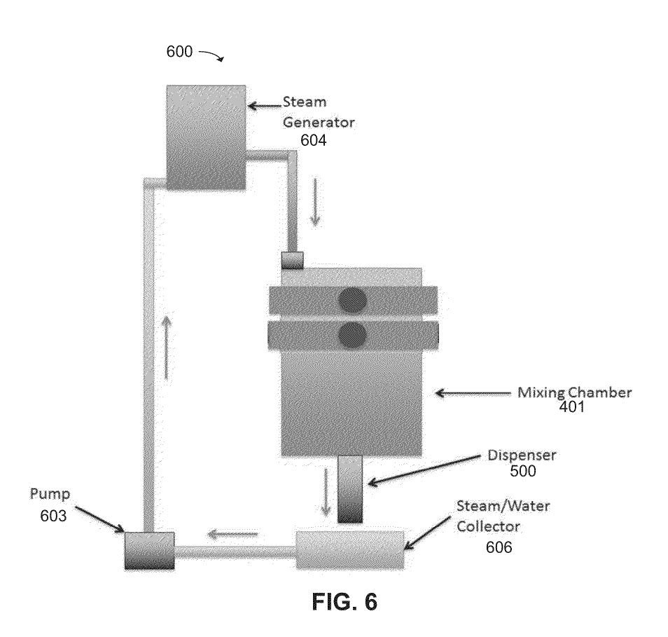

Once the food preparation process has been completed, a cleaning module 600 as shown in FIG. 6 can be used to sterilizes and clean transport lines, the mixing chamber 401, and the dispenser 500 to maintain sanitary conditions. The cleaning subsystem will consist of an automated pump 603 and steam generator 604 to flush the transport lines, mixing chamber and print head with steam/water. Steam/water collector 606 recovers the used water and added surfactant and uses nanofiltration to remove contaminants so that the water can be re-used. Such filtration systems are commercially used to remove solid impurities down to the size of viruses from water streams.

In some embodiments, the food dispensing, mixing, and deposition process will need to be repeated several times for different portions of a prepared food, with the system cleaning module operating between each separate food type. For example, the system might prepare and deposit a layer of a first food type, followed by a cleaning cycle, prepare and deposit a layer of a second food type, followed by another cleaning cycle, then prepare and deposit another layer of the first food type. In other embodiments, multiple mixing chambers and dispensers may be used to accelerate meal preparation so that some of the subsystems or modules can work in parallel. For example, several powder dispensers and mixing chambers can operate work at the same time to create the desired base and toppings for an assembled dish or meal.

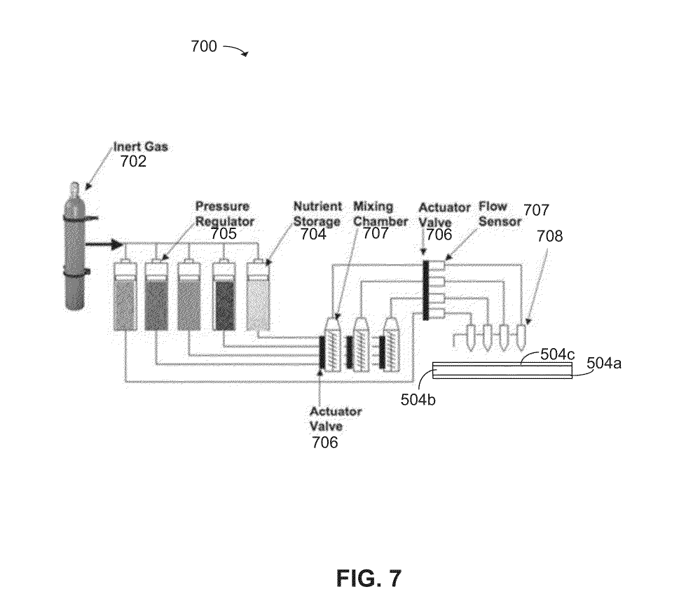

FIG. 7 illustrates schematically another embodiment of a 3D printed food system 700 in which the transfer, mixing, and deposition of stored food content is accomplished using pneumatics and a supply of a compressed gas, such as nitrogen or argon. Compressed gas is stored, for example, in a pressurized tank 702 which is connected to nutrient storage cartridges 704 via pressure regulators 705 controlled by a separate microcontroller. A pressure regulator 705 can be used to allow pressurized gas to flow into the storage cartridges 704 where the contents can be forced out by a pneumatic piston or other similar means. The gas then forces the nutrient components into the mixing chamber 707, as controlled by actuator valves 706. Once in the mixing chamber, the nutrient components, along with sufficient water or oil to create a paste of a desired viscosity, and be mixed, for example, by pneumatically operated pistons. The mixture is then transferred to a nozzle and/or spray valves 708 for deposition onto the heated bed. A pneumatically operated system requires a separate compressed gas source, but has the advantage of avoiding any contact between the nutrient components or mixture and any augers or pumps, thus greatly minimizing clean-up between depositions of different food mixtures or when the process is completed.

Any desired combination of basic food stuffs, whole foods or food ingredients and/or isolated macro- and micronutrients can be stored and used for food preparation. Macronutrients, which form the portion of the diet required for sustenance, can be rapidly produced in a variety of shapes and textures directly from a 3D printer according to embodiments of the invention. Additional food textures can be achieved by adding liquids or baking.

In some embodiments, macronutrients can be provided by a variety of commonly used basic food stuffs, such as flour or tomato sauce, that can be pre-prepared and stored for use in meal preparation. In some embodiments, the stored food components can include isolated macronutrients, such as protein, carbohydrates, and fat, which have been dried and powdered for more efficient storage. The macronutrient powder can be combined with water or oil at the print head immediately before use to form a paste that can be deposited onto the printer stage or bed. This serves to greatly minimize spoilage and waste. Food components, including carbohydrates, proteins and macro- and micro-nutrients, stored in powder form with all or most of the moisture removed can be expected to last for decades without spoiling or degrading. Further, since only the precise amount of macronutrient powder required by the recipe is mixed with liquid for deposition by the print head, there is little or no waste of the macronutrient compound in the printing/manufacturing process.

Among the macronutrient feed stocks, proteins offer the greatest level of structural control in foods due to their wide range of source material and activity. Many proteins are surface active, allowing formation of emulsions and foams. Most will produce gels, and the physical properties of these gels can be finely tuned based on multiple factors including concentration, pH, ionic strength and valence and thermal processing. For example, whey proteins alone, at the same concentration, can form gels ranging from soft and nearly fluid (i.e. yogurt) to stiff and brittle (i.e. Swiss cheese) by slightly altering the pH (4.5-7.0), ionic strength (5-100 mM), ionic valence (Na+;Ca2+) and/or thermal processing conditions. When incorporated into more complex formulations including carbohydrates and/or fats and oils, proteins serve to bind disparate phases and provide elasticity and “toothsomeness” (bread, pasta) or stability between immiscible materials (mayonnaise, sports/nutritional beverages).

Starch and other carbohydrates offer another level of control based on their natural granular structure. By controlling moisture content and thermal processing conditions, product textures ranging from soft gels (pudding) to crispy/crunchy (potato chips, hard pretzels) can be achieved. If temperatures are held below the gelatinization temperature of the native starch granule during processing (45-60° C.), considerable volumes of water can be added to plasticize the rheological properties of the dough without sacrificing the ability to form crunchy textures upon cooking. Alternatively, viscous fluids or gels with (or without) significant yield stress can be produced from a low viscosity slurry by heating the starch above its gelatinization temperature. These are important processing variables that can allow for decreased energy input during formulation without loss of product quality and attributes.

A reasonable range of product textures to emulate may be represented by yogurt, peanut butter and al dente pasta. Yogurt is a “soft” gel with a minimum yield stress. Peanut butter possesses both a significant yield stress and a significantly higher viscosity than that of yogurt. Al dente pasta represents a semi-firm solid which can be formulated to display either a yield stress or fracture, depending upon the preferences of the astronaut. These textures should be amenable to production from a minimum number of dry ingredients plus water and/or oils, and can be easily adapted to include additional nutritious fats or oils if necessary for dietary requirements.

Since basic sustenance will not ensure the long term physical and mental health of the crew, low volume micronutrients as well as flavors and/or texture modifiers can be added as the food is processed by the 3D printer. In some embodiments, these compounds can be mixed directly with the macronutrients during processing, while in other embodiments they can be added to or sprayed on the macronutrient mixture after deposition by the 3D print head. Based on the crew's gender and nutritional needs, additives such as folic acid and lycopene can be supplied directly into the food either during the mixing process before dispersion by the 3D printer or by separate microjets similar to an inkjet printer jet. For example, spherical dry starch could be added to protein, water, and flavor. This mixture is blended and dispersed into the desired shape while it still has a low viscosity. After processing, the starch adsorbs the water, thickening or solidifying the food. Analogously, maltodextrin can be added to fats to produce a “dry” product. Other examples of micronutrients that could be used in particular embodiments include ascorbic acid (vitamin C),calcium, chromium, cobalamin (vitamin B12), folic acid (folate), iron, iodine, magnesium, niacin (vitamin B3), potassium, pyridoxine (vitamin B6), riboflavin (vitamin B2), selenium, sodium, vitamin A, beta carotene, vitamin D, vitamin E, vitamin K, zinc, and omega-3 and omega-6 fatty acids.

Embodiments of the invention described herein provide a method and apparatus that can be used to greatly extend the shelf life of food far beyond that known in the prior art. An automated 3D printer equipped with a mixing system and dispensing nozzle can be used for producing food with a long shelf life of at least 30 years, at least 15 years, or at least 5 years. Food components to be dispensed, including carbohydrates, proteins and macro- and micro-nutrients, are stored in powder form with all or most of the moisture removed. In that form, the food components can be expected to last for decades without spoiling. Once moisture is reintroduced, however, the micronutrients, macronutrients, and flavor recipes can be used to produce a wide range of foods for flavor, dietary needs, and general health.

Embodiments of the invention described herein also provide a method and apparatus that can be used to account for any micronutrient decay that may occur if the food components are stored for long periods of time. Such a feature would obviously be highly desirable for long-term space applications since food stocks cannot be easily replaced during the mission. Decay rates and any byproducts produced for particular stored nutritional components (whether macronutrient components or store isolated micronutrients) and for prepared foods or dishes can be readily determined using conventional methods. To account for such micronutrient decay at room temperature, a reintroduction algorithm can be based upon decay rate and elapsed time to determine the amounts of additional micronutrients or flavoring to add recipes in order to compensate for the resulting decrease in nutritional value. In this way, the nutritional profiles of prepared food can remain substantially constant whether the stored food components are completely fresh or several years old.

In similar fashion, micronutrients and/or flavorings can be added to any food prepared according to embodiments of the invention so that nutritional content and taste can be customized for each individual user. Additional micronutrients can also be added to prepared foods in order to improve their nutritional content beyond that of a similar foods or dishes prepared by conventional methods. For example, isolated vitamins or other nutritional content could be added to food such as chocolate or another dessert that would normally be lacking any significant nutritional benefit.

Finally, in some embodiments, recipes can also be automatically adjusted based upon feedback from previously prepared meals and/or upon the inventory or age of related or interchangeable nutritional components. Recipes developed in a laboratory may not work as expected in the field under different conditions and with different equipment. In some embodiments, feedback on food prepared according to a given recipe can be used to modify the recipe for future use. For example, if a prepared food product is undercooked or not seasoned appropriately, the stored recipe could be modified to cook the meal longer or to add additional seasoning. Recipe modifications could also be done on an individual basis. For example, if one system user were to continually rate meals as too spicy, future recipes prepared for that user could automatically reduce the spices required by the recipe, even if that user have never eaten a particular recipe before. In some embodiments, the 3D printed food system could have integrated testing capabilities such as a thermometer to check internal temperatures as a dish is cooking. In the event that the internal temperature is too low, not only could the cooking time be extended for the meal being prepared, but the recipe could also be updated so that future use of the recipe either uses the extended cooking time or at least notifies the user of the potential for the food being undercooked.

Embodiments of a 3D printed food system can also be used to provide particular, customized therapeutic diets as specified by medical personnel in the event that an astronaut is ill or injured. Special therapeutic diets can be pre-programmed or developed on an as-needed basis and transmitted to the ship. Since not all scenarios will be known before mission launch, such food dispensing systems should include an adaptable redundant food supply.

Although much of the discussion herein has focused on the application of embodiments of the present invention to manned space missions, other applications are also possible. For example, a 3D printed food system according to the present invention can also reduce military logistics, disposal waste, increase operational efficiency and mission effectiveness especially during wartime. In addition, 3D printed food can provide optimal nutrients to the soldiers depending on their personal needs and level of physical activities. Submarines and aircraft carriers can effectively benefit from 3D printed food system, which may reduce their downtime to refill supplies and provide efficiency in executing their missions. Military personnel can utilize 3D printed food system to increase their effectiveness in remote operating base by cutting down food drop off trips and waste disposals.

Long duration expeditions to North Pole, South Pole and other extreme environments can utilize 3D printed food technology to obtain hot and nutrient rich food. The basic ingredients can sustain for longer durations and provide an optimal nutrient food source without generating any waste.

3D printing according to the present invention has the capacity to provide an order of magnitude higher efficiency to the current supply-chain network by eliminating many steps of the food chain. Currently, the world population is approximately 7 billion. It is anticipated that the population will reach 12 billion by the end of the century. The current infrastructure of food production and supply will not be able to meet the demand of such a large population. To meet the sustainable food infrastructure, the current network will need to provide a very high level of efficiency. Conventional technologies can only provide marginal efficiency, which is not enough to keep food prices at an affordable level for the population growth. A new dimension of exploring disruptive technologies to meet food demand is essential. 3D printing has the capacity to provide an order of magnitude higher efficiency to the current supply-chain network by eliminating many steps of the food chain.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

The accompanying drawings are not intended to be drawn to scale. For purposes of clarity, not every component may be labeled in every drawing.

The invention described herein has broad applicability and can provide many benefits as described and shown in the examples above. The embodiments will vary greatly depending upon the specific application, and not every embodiment will provide all of the benefits and meet all of the objectives that are achievable by the invention. Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present). Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus for producing a three-dimensional edible composition, said apparatus comprising:
a plurality of storage containers for holding food components in powder or liquid form;
a print head for depositing a fluid food component mixture onto a substrate in successive layers;
a mixing chamber for blending food components until a desired composition and viscosity is reached;
a feeder for delivering a metered amount of a food component from a storage container to the mixing chamber;
a mixture delivery system for delivering blended food components to the print head;
a controller adapted for receiving a set of instructions specifying compositions to be added to a food mixture and issuing movement commands in response thereto;
a print head positioning system in communication with said controller;
wherein the blended food component is deposited onto a substrate by the print head at desired locations in successive layers to create a desired three-dimensional structure formed from the blended food components.

2. An apparatus for producing a three-dimensional edible composition, said apparatus comprising:
storage containers for holding a plurality of food components in powder or liquid form, at least one food component being an isolated macronutrient;
a mixing chamber for blending food components until a desired composition and viscosity is reached;
a plurality of feeders for delivering a metered amount of a plurality of food components from their storage containers to the mixing chamber;
a nozzle for depositing a fluid food component mixture onto a substrate in successive layers;
a mixture delivery system for delivering blended food components to the nozzle;
a controller adapted for causing specified amounts of specific food components to be delivered to the mixing chamber and for controlling the movement and operation of the nozzle in response to set of instructions;
a nozzle positioning system in communication with said controller;
wherein the blended food component is deposited onto a substrate by the nozzle at desired locations in successive layers to create a desired three-dimensional structure formed from the blended food components.

3. An apparatus for producing a three-dimensional edible composition in which a 3D printing process is used to combine precisely metered amounts of stored food components, said food components including at least macronutrient selected from the group of isolated protein, carbohydrates, or fat, and at least one isolated micronutrient, deposit the food components onto a substrate, and heat the deposited food components to a desired temperature.

4. Any of the preceding claims in which the apparatus is adapted for performing a programmable automated process by controlling the storage, mixing, and deposition systems.

5. A method of producing an edible composition, the method comprising:
retrieving a precisely metered amount of each of a plurality of stored food components;
mixing the retrieved food components in a mixing chamber to form a paste having a desired composition and viscosity;
delivering the paste to a nozzle adapted for a 3D printing process;
depositing the paste onto a substrate at desired locations in successive layers to create a three-dimensional structure formed from the mixture of food components; and
heating the three-dimensional structure to produce an edible composition.

6. The method of claim 4 in which the method parameters are controlled by a set of instructions specifying the stored food components and amounts, the mixing parameters, the nozzle flow rate and desired locations for depositing the past, and/or the heating time and temperature.

7. The method of claim 4 in which the method is computer controlled.

8. The method of claim 4 in which the method is automated.

9. The method of claim 4 further comprising:
retrieving a second precisely metered amount of each of a plurality of stored food components;
mixing the second retrieved food components in a mixing chamber to form a second paste having a desired composition and viscosity;
delivering the second paste to a nozzle adapted for a 3D printing process;
depositing the second paste onto a substrate or onto the first deposited paste at desired locations in successive layers to create a three-dimensional structure formed from the mixture of food components.

10. Any of the preceding claims in which the food components comprise isolated macronutrients in powdered form.

11. Any of the preceding claims in which the food components comprise isolated protein, or carbohydrates in powdered form.

12. Any of the preceding claims in which the food components comprise isolated protein and/or carbohydrates in powdered form and in which the powdered protein or carbohydrates are combined with water or edible oil before delivery to the nozzle.

13. Any of the preceding claims in which the food components comprise isolated micronutrients stored as powders, aqueous solutions, or dispersions.

14. Any of the preceding claims in which the food components comprise a sufficient number of different food components to allow the production of a variety of different edible compositions, each having a distinct composition and flavor.

15. Any of the preceding claims in which the edible composition comprises a synthetic food.

16. Any of the preceding claims in which the edible composition comprises an edible composition that is at least partially manufactured by combining isolated nutritive substances.

17. Any of the preceding claims in which the edible composition comprises an edible composition that is at least partially manufactured by combining isolated nutritive substances, said isolated nutritive substances comprising isolated proteins or their component amino acids, carbohydrates, fats, vitamins and/or minerals.

18. Any of the preceding claims in which the instruction specifying food components to be added to a food mixture are modified to compensate for decay over time in the nutritional values of the stored food component by adjusting the amounts of micronutrients to be added to the food mixture.

19. Any of the preceding claims in which the apparatus further comprises a heater for cooking or warming the blended food component deposited onto the substrate.

20. Any of the preceding claims in which the apparatus further comprises a feedback system for modifying the set of instructions for any future preparation of the edible composition.

21. The method of claim 5 further comprising modifying the instructions to compensate for decay over time in the nutritional values of the stored food component by adjusting the amounts of micronutrients to be added to the food mixture.

22. The method of claim 5 further comprising modifying the instructions to customize the nutritional content of the resulting edible composition by adjusting the amounts of micronutrients to be added to the food mixture.

23. Any of the preceding claims in which the food components are delivered to the mixing chamber via a pneumatic system using pressurized inert gas.

24. Any of the preceding claims in which the blended food components or paste are delivered to the mixing chamber via a pneumatic system using pressurized inert gas.

25. Any of the preceding claims in which the edible composition has a nutritional content that varies across the edible composition.
